(19) United States
(12) Patent Application Publication
(10) Pub. No.: US 2004/0079566 A1
(43) Pub. Date: Apr. 29, 2004

(54) Stator insulation protection system

(75) Inventors: Michael C. Radomile, Erie, PA (US); Ord Allen Randolph III, Erie, PA (US); Alan G. Frampton, Harborcreek, PA (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: General Electric Company

(21) Appl. No.: 10/279,249

(22) Filed: Oct. 24, 2002

(51) Int. Cl. B60K 1/00

(52) U.S. Cl. 180/65.5

(57) ABSTRACT

The present disclosure provides an electric motor for use in a vehicle. The disclosure includes a stator comprising a plurality of stator coils separated by the stator core. The stator coils have insulation thereon. The disclosure further includes an abrasion resistant layer covering at least a portion of the stator coil. The abrasion resistant layer is a porous material capable of resisting the abrasive effect of particulate matter within the air used to cool the motor.

### TECHNICAL FIELD

The present invention relates generally to electric motors. More specifically, it relates to an improved process for the protection of coil insulation in electric motors cooled with air containing abrasive particles.

### BACKGROUND OF THE INVENTION

Locomotives and large industrial trucks typically use electric motors to mobilize the vehicle. Diesel engines on the vehicle are attached alternators to generate electricity to power the motors, and air from the external environment vehicle is used to cool the motors. For example, U.S. Pat. No. 6,148,940 discloses an AC motorized wheel arrangement that uses air from the exterior of an industrial truck to cool a pair of drive motors. Typically, these vehicles are utilized in environments that have a high concentration of grit and dust. Because the electric motors use air for cooling the motors that has been taken from the work environment with little or no filtering, the cooling air has a sandblasting effect when circulated through the motor. It has been found that this sandblasting effect can eventually erode the insulation from stator coils used to energize the stators of the motor and cause failure of the motor.

### SUMMARY OF THE INVENTION

The present invention provides an electric motor for use in a vehicle. The invention comprises a stator comprising a plurality of stator coils inserted into the stator core. The stator coils are made of copper conductors having insulation thereon. The invention further comprises an abrasion resistant layer covering at least a portion of the stator coil. The abrasion resistant layer is a porous material capable of resisting the abrasive effect of particulate matter within the air used to cool the motor.

### BRIEF DESCRIPTION OF THE DRAWINGS

The features of the invention believed to be novel are set forth with particularity in the appended claims. The invention itself, however, both as to organization and method of operation, together with further objects and advantages thereof, may best be understood by reference to the following description taken in conjunction with the accompanying drawings, where like numerals represent like components, in which:

FIG. 1 is a sectional side view of one embodiment of the present invention;

FIG. 2 is a partial cut out and perspective view of the embodiment of FIG. 1;

FIGS. 3-6 are respective rear, side, perspective, and top views of a cooling embodiment of the present invention;

FIG. 7 is a side view of a portion of a motor frame having cooling air holes;

FIG. 8 is a partial view of the stator, stator coils and abrasion resistant layer of an embodiment of the present invention;

FIG. 9 is a side and top view of a insertion of the abrasion resistant layer of an embodiment of the present invention.

FIG. 10 is a top view of the felt being held in place by the tip of the wedge and a small felt pad. This process is to secure the felt prior to VPI.

### DETAILED DESCRIPTION OF THE PREFERRED EMBODIMENT

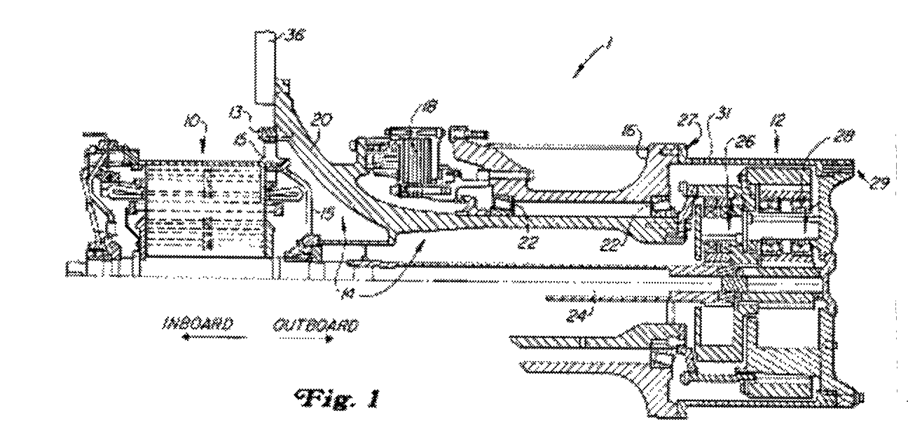

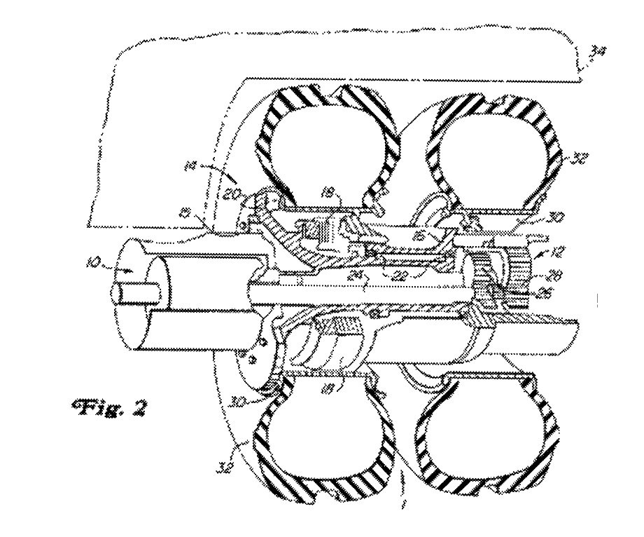

FIG. 1 is a sectional side view of one embodiment of the present invention, and FIG. 2 is a partial cut out and perspective view of the embodiment of FIG. 1. An AC motorized wheel arrangement 1 of the present invention includes an AC motor 10, a transmission 12, a wheel frame 14, a wheel hub 16, and a service brake 18. A truck with which the motorized wheel will be used is shown in block form as element 34 in FIG. 2.

A single motorized wheel is shown in FIGS. 1 and 2. In practice, two motorized wheels are used with the other, unshown motorized wheel substantially similar to a mirror image of that shown in FIG. 1. For purposes of the present invention, as shown in FIG. 1, the term “outboard side” with respect to a motorized wheel, means a portion of the motorized wheel in the direction of the outboard arrow (away from a center line of the truck) and the term “inboard side” refers to a portion of the motorized wheel in the direction of the inboard arrow.

Wheel frame 14 supports the motorized wheel components and includes a flange 20 that can be bolted directly to an axle box 36 of the truck. In one embodiment, a motor frame 15 of the AC motor is mounted with bolts 13 on a portion of the wheel frame on the inboard side of the wheel, and the transmission is mounted to a portion of the wheel frame on the outboard side of the wheel. The wheel frame provides a standard interface to the truck and thus permits easy removal and replacement of the motorized wheel assembly from the truck.

Roller bearings 22 are situated between the wheel frame and the wheel hub for supporting the wheel hub and allowing it to turn on the outside of the wheel frame. The wheel hub is turned by the transmission. Rims 30 and tires 32 are mounted to and rotate with the wheel hub.

The service brake is mounted between the frame flange 20 and wheel hub 16. This is a useful position for the service brake for two reasons: (1) the brake is between the rotating portion (wheel hub) and the stationary portion (wheel frame) of the wheel and (2) the brake can be oil cooled with the wheel frame geometry in the area of the brake providing a reservoir of cooling oil for the brake.

The AC motor converts electrical energy to mechanical energy that turns a shaft 24 connected to the transmission. In one embodiment the transmission comprises a double reduction transmission, and the shaft is connected to a high speed portion 26 of transmission 12. The high speed portion of the transmission then turns the low-speed portion 28 of the transmission that is bolted to the wheel hub with bolts 27 and 29 through a torque tube 31.

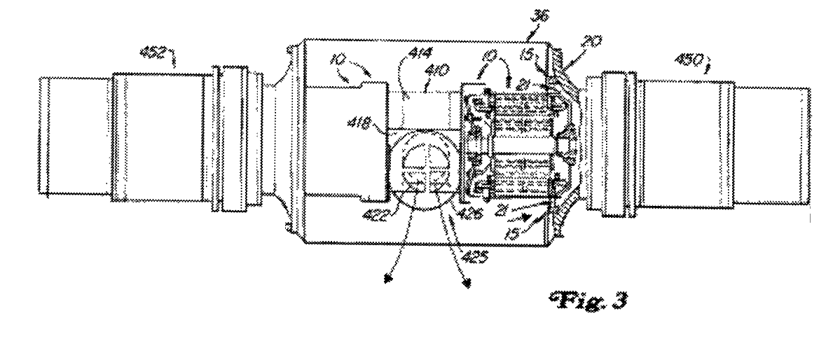

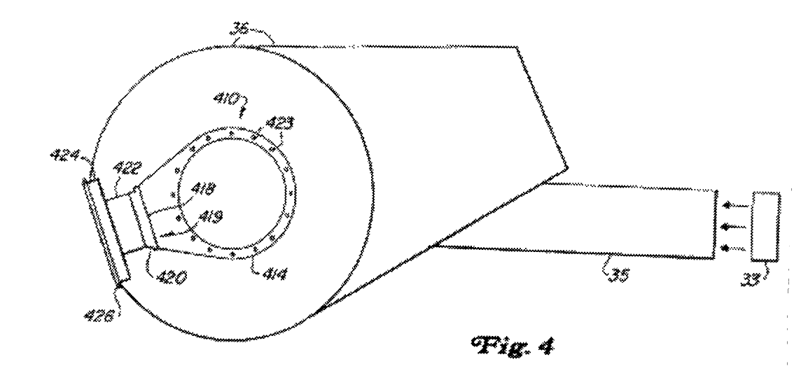

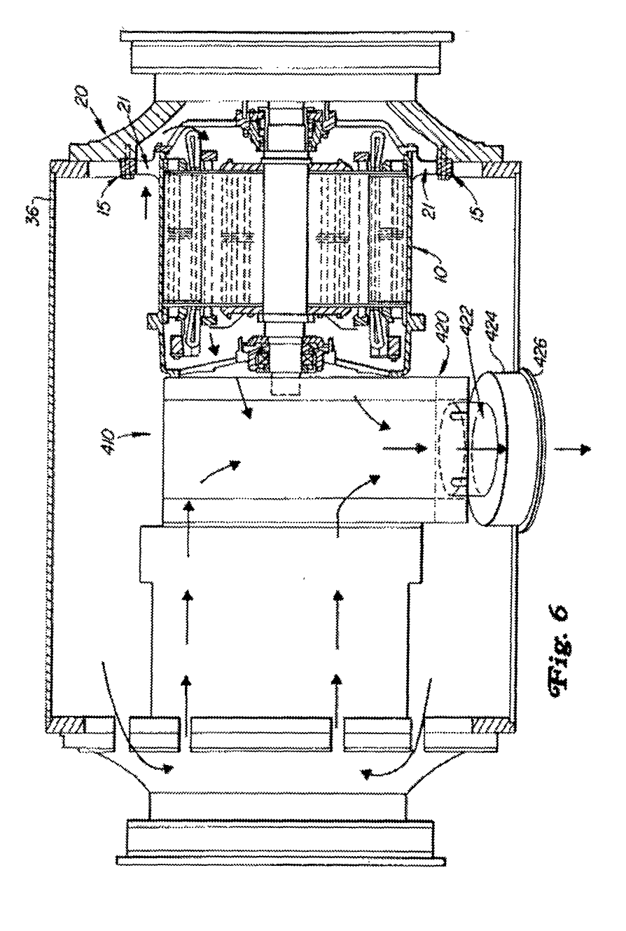

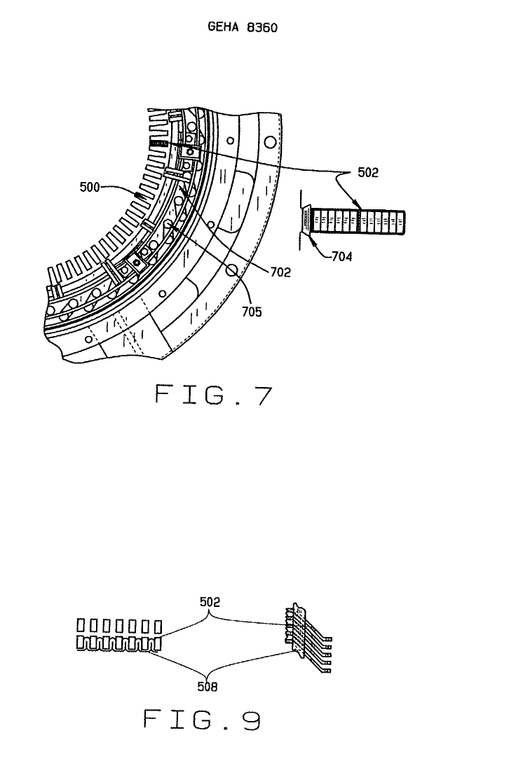

FIGS. 3-6 are respective rear, side, perspective, and top views of a cooling embodiment of the present invention. As shown in FIG. 4, one or more blowers 33 in the front of the truck supply cooling air to axle box 36 through air inlet duct 35. As shown in FIGS. 3 and 6, cooling air from the axle box enters the motors through air holes 21 which are provided in motor frames 15 (which are secured with bolts 13 to flanges 20 of frames 14 of wheels 450 and 452). FIG. 7 shows a portion of the stator core 500 and the stator frame 702 with axial vent holes 705. The stator coil 502 is held in the stator slot by a wedge 704 that is driven into the slot over the coil. Air enters the motors from the outboard ends of the motors and passes through motors 10 toward the inboard ends. The motors are attached to an air outlet housing element 410 that directs the air through an opening 425 in the rear of the axle box.

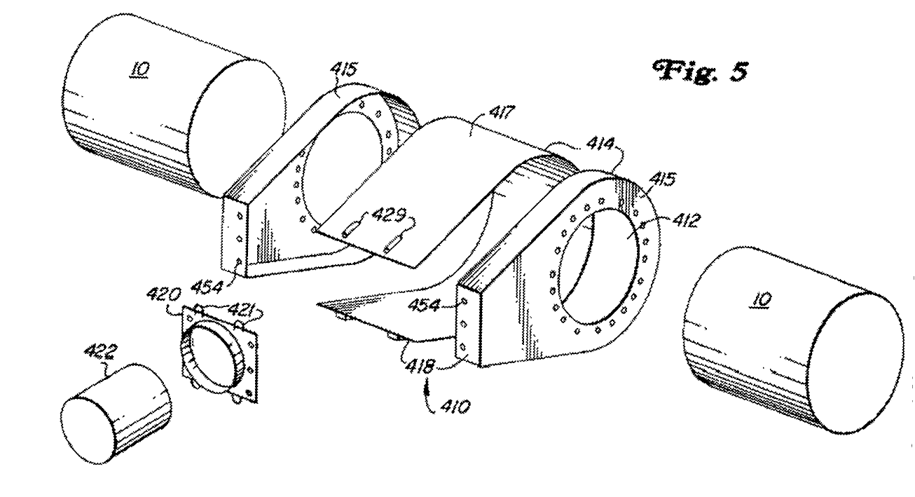

As shown in FIGS. 4 and 5 the outlet housing preferably includes a cylindrical portion 414 having two circular openings 412 corresponding to the two motors. The outlet housing can be attached to the motors with any appropriate device. In one embodiment, the motors are bolted to the outlet housing with bolts 423. The outlet housing can be tapered to provide a smaller air outlet opening 419 that is shown as a rectangular portion 418. In one embodiment, the outlet housing can be angled in a downward direction. Tilting the outlet housing downwards is useful for preventing debris from falling into the air outlet from the truck body or from the top of the axle box.

The rectangular portion of the outlet housing can be attached to a hose 422 by a housing coupler 420 which can further narrow the available air path, and the hose can be coupled by an axle box coupler 424 to create an opening having the same diameter as the axle box opening. In one embodiment, outlet housing 410 and couplers 420 and 424 comprise sheet steel, hose 422 comprises a flexible air duct hose, and cover 426 comprises steel.

As shown in FIG. 5, in one embodiment outlet housing 410 may comprise three portions: two side cowlings 415 and a center wrap portion 417. This structure provides easy access for bolting the cowlings 415 to the frames of motors 10. Housing coupler 420 may be secured with bolts 454 to the side cowlings. Center wrap portion 417 may include tabs 429 that fit through loops 421 of the housing coupler to secure the center wrap portion of the outlet housing to the housing coupler.

Although hose 422 and couplers 420 and 424 are shown as having circular cross-sections, the present invention does not require a specific shape for the cross sections. Furthermore, the air path does not need to be narrowed in the manner shown in FIGS. 3-6.

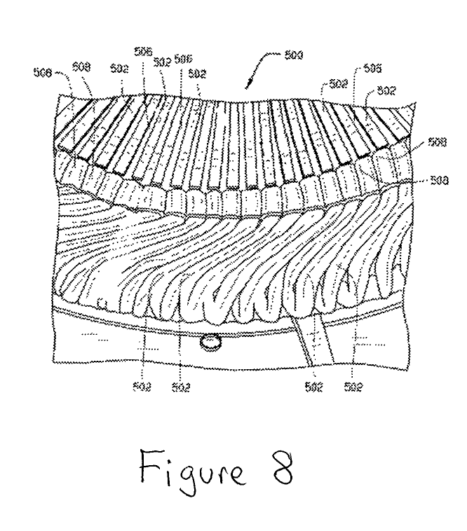

FIG. 8 shows the stator 500 of one of the motors. The stator coils 502 are separated by the stator core 506. To prevent gritty air entering the outboard ends of the motors (FIG. 6) from abrading the insulation of stator 500, the exposed surfaces of the coils 502 are covered with an abrasion resistant layer 508. The abrasion resistant layer 508 is preferably a porous strip material that is pliable and has a temperature rating of at least 160 degrees Celsius. The abrasion resistant layer 508 most preferably comprises a felt material that exhibits good dimensional stability and little swelling when saturated with varnish (described below). The term varnish is used generally to describe an impregnating resin which, when cured, provides dielectric strength, moisture resistance and mechanical bonding. Additionally, felt is preferred due to its ability to absorb and retain a large quantity of varnish.

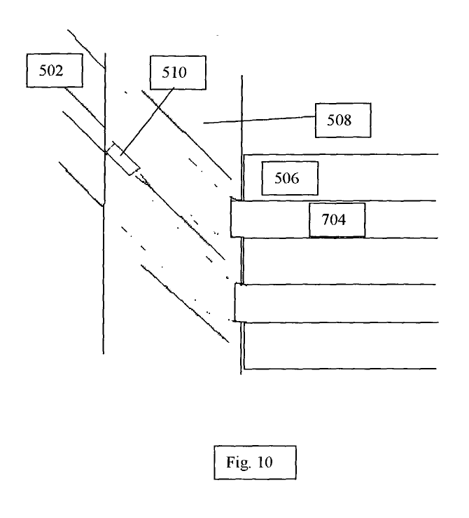

The abrasion resistant layer 508 is woven between each stator coil 502 as shown in FIG. 9. Alternatively, the abrasion resistant layer may comprise several small strips 510 that together comprise the abrasion resistant layer 508. The abrasion resistant layer is held in place by the tip of the wedge (704) next to the core and by the small felt strips (510) inserted between the coils shown in FIG. 10. After installation, abrasion resistant layer 508 is subjected to a known VPI (vacuum-pressure-impregnation) process that saturates the abrasion resistant later 508 with varnish and then is baked to harden the varnish. While the abrasion resistant layer is described pliable, the abrasion resistant layer could be a premolded strip or several premolded portions.

The hardened, varnish-impregnated abrasion resistant layer 508 exhibits excellent resistance to the “sandblasting” effect of the cooling air blown through the motor and protects the stator coil insulation from erosion. Further, the abrasion resistant layer fills the air gap between the stator coils 502 thereby reducing noise that would other wise be transmitted through the air gap. As a result, the noise wads used in AC electric motors to suppress the operating noise of the motor are no longer required.

While only certain preferred features of the invention have been illustrated and described herein, many modifications and changes will occur to those skilled in the art. It is, therefore, to be understood that the appended claims are intended to cover all such modifications and changes as fall within the true spirit of the invention.

We claim:

1. An electric motor for use in a vehicle intended for use in an environment having air with a high concentration of particulate matter, the electric motor comprising a stator and stator coil wherein a porous abrasion resistant layer capable of resisting the abrasive effect of the particulate matter within the air when the air is used to cool the motor, wherein porous abrasion resistant layer is woven between the stator coil such that the at least a portion of the stator coil is covered by the porous abrasion resistant layer and the porous abrasion resistant layer is capable of absorbing and retaining varnish when subjected to a vacuum/pressure impregnation process.

2. The motor of claim 1 wherein the abrasion resistant layer is applied to the stator coils immediately adjacent to the stator.

3. The motor of claim 1 wherein the abrasion resistant layer comprises varnish-impregnated felt.

4. The motor of claim 3 wherein the abrasion resistant layer comprises a single strip of felt woven between the stator coils.

5. The motor of claim 3 wherein the abrasion resistant layer comprises a plurality of strips of felt.

6. The motor of claim 1 wherein the abrasion resistant layer comprises premolded strips of material.

7. A motorized wheel arrangement for use in a vehicle intended for use in an environment having air with a high concentration of particulate matter, comprising:
first and second wheel frames adapted to attach to a vehicle body; first and second wheel hubs rotatably supported by said first and second wheel frames, respectively;
first and second motors attached to said first and second wheel frames, respectively;
first and second transmissions operably connected to said first and second motors, respectively;
an air outlet housing positioned between said first and second motors;
wherein the first and second motors each further comprise a stator and stator coils wherein a porous abrasion resistant layer capable of resisting the abrasive effect of the particulate matter within the air when the air is used to cool the motor; and
wherein the porous abrasion resistant layer is woven around the stator coils such that the at least a portion of the stator coils is covered by the porous abrasion resistant layer and the porous abrasion resistant layer is capable of absorbing and retaining varnish when subjected to a vacuum/pressure impregnation process.

8. The motor of claim 7 wherein the abrasion resistant layer is applied to the stator coils immediately adjacent to the stator.

9. The motor of claim 7 wherein the abrasion resistant layer comprises varnish-impregnated felt.

10. The motor of claim 9 wherein the abrasion resistant layer comprises a single strip of felt woven between the stator coils.

11. The motor of claim 9 wherein the abrasion resistant layer comprises a plurality of strips of felt.

12. The motor of claim 7 wherein the abrasion resistant layer comprises premolded strips of material.

13. An electric motor for use in a vehicle comprising:
a stator comprising a plurality of stator bars separated by insulator bars and attached to stator coils having insulation thereon;
a porous abrasion resistant layer capable of resisting the abrasive effect of the particulate matter within the air when the air is used to cool the motor; and
wherein the porous abrasion resistant layer is woven around the stator coils such that the at least a portion of the stator coils is covered by the porous abrasion resistant layer and the porous abrasion resistant layer is capable of absorbing and retaining varnish when subjected to a vacuum/pressure impregnation process.

14. The motor of claim 13 wherein the abrasion resistant layer is applied to the stator coils immediately adjacent to the stator.

15. The motor of claim 13 wherein the abrasion resistant layer comprises varnish-impregnated felt.

16. The motor of claim 15 wherein the abrasion resistant layer comprises a single strip of felt woven between the stator coils.

17. The motor of claim 15 wherein the abrasion resistant layer comprises a plurality of strips of felt.

18. The motor of claim 13 wherein the abrasion resistant layer comprises premolded strips of material.
